(19) United States
(12) Patent Application Publication
(10) Pub. No.: US 2015/0317866 A1
(43) Pub. Date: Nov. 5, 2015

(54) SYMBOL MATCHING GAMES WITH FREE GAME AWARDS

(71) Applicant: ECLIPSE GAMING SYSTEMS, LLC, Lawrenceville, GA (US)

(72) Inventors: Jack Saltiel, Lawrenceville, GA (US); Carlos Lozano, Dacula, GA (US); Robert Brown, Greenville, SC (US)

(73) Assignee: ECLIPSE GAMING SYSTEMS, LLC, Lawrenceville, GA (US)

(21) Appl. No.: 14/269,426

(22) Filed: May 5, 2014

(51) Int. Cl. G07F 17/32; G07F 17/34

(52) U.S. Cl. CPC G07F 17/3213; G07F 17/3225; G07F 17/34

(57) ABSTRACT

In one embodiment, a method comprising executing a symbol matching game; electronically providing during the execution a first monetary award responsive to a defined quantity of matches between user-inputted symbol selections and a first plurality of symbols; and electronically providing during the execution an award of one or more free plays.

### TECHNICAL FIELD

The present disclosure is generally related to electronic gaming systems and, more particularly, casino-type electronic gaming systems.

### BACKGROUND

Casino-type electronic gaming systems encompass a variety of gaming markets, including U.S. tribal gaming, licensed gaming, charitable gaming, and video lottery and electronic pull-tab applications. Symbol or pattern matching games, such as Keno or Bingo, are popular games because of they are easy to learn and involve little in the way of strategy. In Keno, for instance, a player is provided with a display screen of a card or field comprising a plurality of numbers (e.g., 1-80) that correspond to numbered balls graphically presented on the display screen. A player selects (or a game processor selects for the player, such as a quick pick) a defined quantity of numbers (e.g., generally 1-10) from the numbers on the card and provides his or her wager. A random number generator or pseudo random number generator generates winning numbers (e.g., a quantity of twenty (20), analogous to drawing winning-numbered balls in conventional machines). A defined match between the generated (drawn) numbers and the user-inputted numbers results in a monetary award as set forth according to pay tables in the system, with progressive awards also available to the player based on the wager.

### BRIEF DESCRIPTION OF THE DRAWINGS

Many aspects of the disclosure can be better understood with reference to the following drawings. The components in the drawings are not necessarily to scale, emphasis instead being placed upon clearly illustrating the principles of the present disclosure. Moreover, in the drawings, like reference numerals designate corresponding parts throughout the several views.

FIGS. 1A-1B are screen diagrams that illustrate example display screens provided before play commencement in an embodiment of an example symbol matching game system.

FIGS. 2A-2B are screen diagrams that illustrate example display screens provided upon execution of play in an embodiment of an example symbol matching game system.

FIG. 3 is a block diagram of an embodiment of an example symbol matching game system.

FIG. 4 is a flow diagram that illustrates an embodiment of an example symbol matching game method.

### DESCRIPTION OF EXAMPLE EMBODIMENTS

### Overview

In one embodiment, a method comprising executing a symbol matching game; electronically providing during the execution a first monetary award responsive to a defined quantity of matches between user-inputted symbol selections and a first plurality of symbols; and electronically providing during the execution an award of one or more free plays.

### DETAILED DESCRIPTION

Certain embodiments of a symbol matching game system and method are disclosed that provides players of symbol matching games with one or more free plays in addition to monetary awards (e.g., game outcome awards, jackpot or progressive awards). In one embodiment, the symbol matching game system provides a display of two visually distinguishable and demarcated fields of symbols (e.g., numbers, letters, graphic icons that are numbered, lettered, or otherwise distinguished, or other symbols or patterns) and receives user-inputted symbol selections (e.g., user-selected, or automatically generated such as via selection of a quick pick button or button icon). The symbol matching game system then presents adjacent the fields random or pseudo random generated winning symbols, and further provides for monetary awards based on a defined match (e.g., 10 matches, 9 matches, etc.) between the user-inputted symbol selections and machine-generated (e.g., random or pseudo-random number generator of a gaming machine or game server) symbols, as is conventionally done, as well as one or more free play awards based on a defined quantity of matches between the machine generated symbols and symbols of either one of the plural (e.g., two) fields.

Digressing briefly, conventional symbol matching games provide for monetary awards based on the aforementioned defined matches between the user-inputted symbol selections and the machine-generated symbols, but do not offer a free play option as an award. In certain embodiments, the symbol matching game system provides the additional one or more free play awards, resulting in increased interest in these types of games and potentially more revenue for the host facilities.

Having summarized certain features of one or more symbol matching game systems of the present disclosure, reference will now be made in detail to the description of the disclosure as illustrated in the drawings. While the disclosure will be described in connection with these drawings, there is no intent to limit it to the embodiment or embodiments disclosed herein. For instance, although Keno-type games are described and illustrated in the present disclosure, other types of symbol matching games (e.g., Bingo, Lotto, Roulette, etc.) also benefit from certain embodiments of symbol matching game systems, and hence are contemplated to be within the scope of the disclosure. Also, although a mechanism for determining free play awards is described herein as based on top or bottom field counts, as described further below, it should be appreciated in the context of the present disclosure that other mechanisms may be used to award free play awards. For instance, the free play award may be based on matching predesignated spots on a field (e.g., a Keno field), matching randomly selected spots on the field, having the awards randomly awarded (e.g., based on some predetermined probability or based on some external event). Further, although the description identifies or describes specifics of one or more embodiments, such specifics are not necessarily part of every embodiment, nor are all of any various stated advantages necessarily associated with a single embodiment. On the contrary, the intent is to cover all alternatives, modifications and equivalents included within the spirit and scope of the disclosure as defined by the appended claims. Further, it should be appreciated in the context of the present disclosure that the claims are not necessarily limited to the particular embodiments set out in the description.

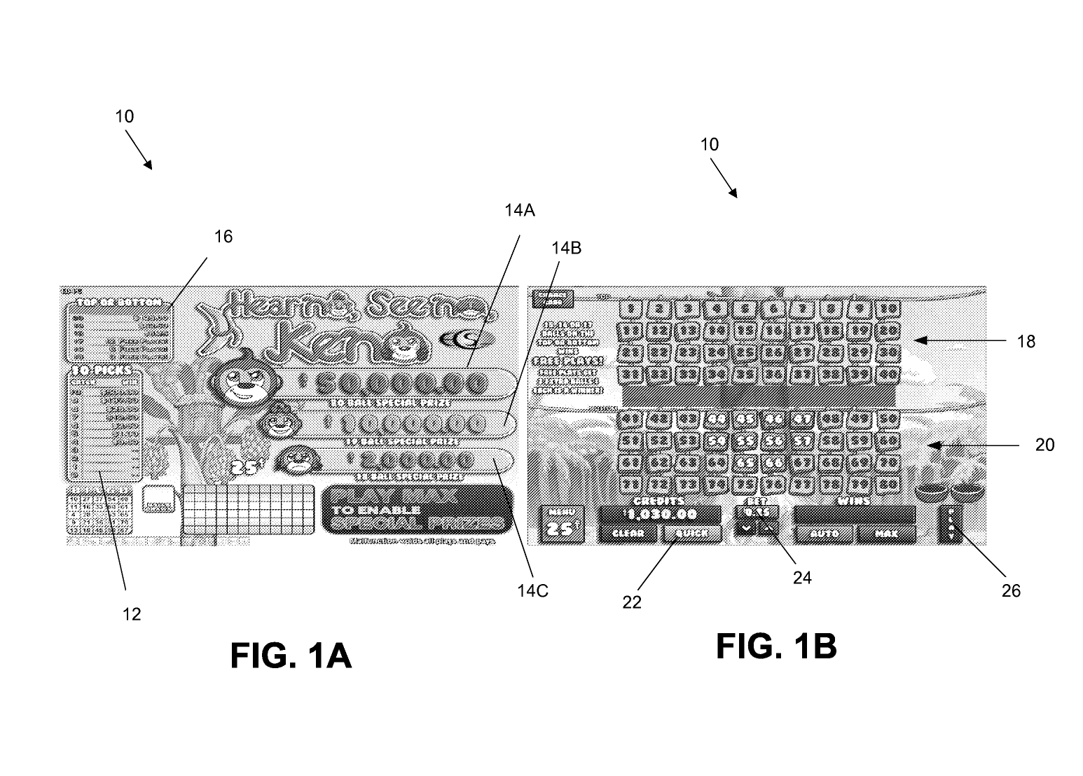

FIGS. 1A and 1B depict some example display screens (also referred to herein as a graphical user interface or GUI, or in general, a display device) of an embodiment of a symbol matching game system that may be presented on one or more gaming machines. It should be appreciated within the context of the present disclosure that the display screens are merely one example among many, and that in some embodiments, other designs and/or features may be presented to a player. Note that the phrase “gaming machine,” as is known, may refer to any device that enables any activity or mode of play for gaming (i.e., gambling or redemption), amusement, competition, or other purposes. Additionally, the phrase “gaming machine” may refer to a “stand alone” player station or console in which case the outcome of game play is determined locally, or as part of a server-based network or bank of gaming machines in which case the outcome of game play is centrally determined. For instance, a gaming machine may be configured as an upright cabinet, as is known, and presents the display screen of FIG. 1A on an upper portion of a cabinet, and the display screen of FIG. 1B on a lower portion of the cabinet. The cabinet may include a wager interface or interfaces (e.g., currency input/output port, card reader, etc.), touch-display screens, electromechanical buttons, or a combination of touch-display screens and electromechanical buttons. In one embodiment, the display screens may be configured as “touch screen” types upon which icons corresponding to some or all of the electromechanical buttons appear, or graphical icons manipulated and/or “selected” by toggles, joysticks, a mouse, among other user interface tools.

In the examples depicted in FIG. 1A, the display screen 10 is embodied as a main game screen for a Keno game prior to game play. A table 12 comprises plural monetary award entries for a match between machine-generated symbols and of the defined quantity of symbols (hereinafter, “numbers” or numbered balls or squares are used interchangeably with “symbols”) selected by a player. For instance, for a match of ten (10) user-selected numbers with the machine generated numbers, the player wins in this example $500.00. For a match of nine (9) user-selected numbers with the machine generated numbers, the player wins in this example $187.50, and so on. Also shown are progressive or jackpot fields 14A, 14B, and 14C, which are based on a match of a defined quantity of machine generated numbers with the play field numbers as described below. In this example, a monetary jackpot award of $50,000 is awarded to a player where 20 machine generated numbers match the fields, $10,000 for 19 matches, and $2000 for 18 matches. It should be appreciated within the context of the present disclosure that these monetary values, as well as the design and/or configuration of the display screen 10 is merely illustrative, and that other values, designs, and/or configurations may be deployed in some embodiments. Also shown in FIG. 1A is a top or bottom field table 16. As depicted in FIG. 1A, the top or bottom field table 16 provides for free play awards based on the number of matches between machine-generated numbers and top or bottom fields of the game. Referring to FIG. 1B, a top field 18 and a bottom field 20 is presented on a bottom screen of the display screen 10. Note that although the fields 18 and 20 are shown as a vertically-aligned arrangement, in some embodiments, the fields may be arranged in another manner (e.g., horizontally), and/or with a different quantity of fields. Referring to the top field 18, shown are a field of forty (40) squares arranged in this example in four (4) rows and ten (10) columns, though other arrangements may be used. The squares of the field 18 are numbered consecutively, though not limited to a consecutive arrangement. The bottom field 20 likewise comprises four (4) rows and ten (10) columns, numbered consecutively from forty-one (41) to eighty (80), though other arrangements and/or manner of sequence may be used in some embodiments. The top field 18 is clearly demarcated from the bottom field 20, though in some embodiments, the demarcation may be achieved in the gaming machine logically (e.g., without a visual demarcation). It is also noted that the numbers 1-80 are evenly distributed among the fields 18, 20 on the screen 10, though some embodiments may deploy a different quantity of numbers between the top and bottom fields 18, 20.

Referring again to FIG. 1A, the top or bottom field table 16 presents to the player a mix of monetary and free game awards based on the quantity of machine-generated numbers matching the numbers in the fields 18 or 20. For instance, for a match of twenty (20) numbers in either the top field 18 or the bottom field 20, a monetary award of $125 is awarded. For nineteen (19) matches in either the top 18 or bottom field 20, a monetary award of $62.50 is awarded to the player. For eighteen (18) matches, $6.25 is awarded. Once again, with these display screen discussions, other manners of arrangement or configuration of the awards and/or designs may be used in some embodiments. The top or bottom field table 16 also comprises plural (e.g., three (3) entries for awarding free plays, including twelve (12) free plays for a match of seventeen (17) machine generated numbers and the numbers of the fields 18 or 20, six (6) free plays for sixteen (16) matches in either field 18, 20, and three (3) free plays for a match of fifteen (15) in either fields 18 or 20. In one embodiment, the award of free plays results in three (3) extra balls.

Referring to FIG. 1B, also shown is a quick button icon 22 for enabling the machine to generate numbers for the user selections, a bet or wager icon 24 to wage a bet, and a play button icon 26 to commence play of the Keno game. Note that user selection of the desired numbers may be made directly on the screen 10 (e.g., in a touch-screen embodiment, where the user touches the desired numbers from the fields 18 and 20), or via manipulation of a cursor or via electromechanical buttons on the cabinet. Other buttons or button icons are shown and un-shown, and omitted from discussion in view of their known use.

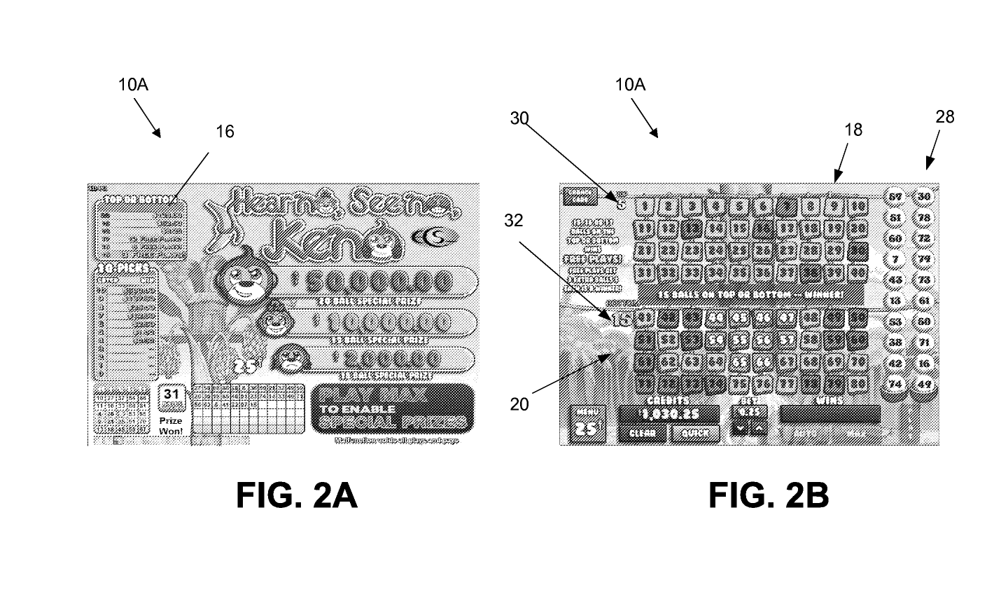

In general, the player picks 2-10 numbers (e.g., 10 in this case) and how much he or she wants to bet via manipulation of the bet icon 24. When the player presses the play button icon 26, the game commences and a defined quantity of numbers (e.g., twenty (20) are generated by the machine, with the resulting display screens 10A shown in FIGS. 2A-2B as described below. In particular, and referring to FIG. 2B, twenty (20) numbers are selected by the host gaming machine random number generator (RNG) or a server RNG coupled to the gaming machine. The twenty (20) numbers are presented on the lower portion of the display screen 10 in a field 28 adjacent the top and bottom fields 18 and 20. In the example depicted in FIGS. 2A and 2B, the player had none of his or her selected numbers covered by the machine-generated numbers presented in the field 28. Thus, in the primary or base keno game, the player loses. However, because fifteen (15) of the machine generated numbers were selected in one of the top or bottom fields 18, 20 (e.g., in this example, the bottom field 20) as highlighted (e.g., darkened squares, though other mechanisms for highlighting the matched numbers may be used) by the matching numbers in the fields 20 (e.g., numbers 42, 43, 49, etc.), the player wins an award from the top and bottom field table 16 (e.g., three (3) free plays, as highlighted in the table). Note that there were matching numbers in the top field 18 (e.g., five (5), as highlighted therein), but the matched quantity does not result in an award according to the top and bottom field table 16. Note that in some embodiments, respective counters 30 and 32 corresponding to matches between the machine generated numbers shown in the field 28 and those in the top and bottom fields 18, 20, respectively, are presented adjacent each field 18, 20. In this example, the counters 30 and 32 show the matches in the top and bottom fields 18 and 20 to be 5 and 15, respectively.

In one example operation, and referring to FIGS. 1A-2B, the player inserts cash, a voucher, player account card, among other monetary value implements, into the gaming machine. The player then presses numbers 1-80 on a suitable user interface of the gaming machine (e.g., a touch screen, keypad, cursor, voice activated, among other input mechanisms). In one embodiment, the player may select between two (2) and ten (10) numbers, though not limited to that range. In some instances, the player may select the quick button icon 22, which randomly makes the Keno picks for the player. The player manipulates the up and down arrow button icons of the wager icon 24 to select the desired play amount. The player may select a maximum bet button icon to select the maximum play amount and start the game. The player selects the play button to commence game play, and responsively, random number generation mechanisms hosted locally or on a server coupled to the gaming machine over a network selects, in one embodiment, twenty (20) Keno balls (numbered balls, or other symbols) and presents them on the display screen 10A. If enough Keno balls match the player picks, as defined in table 12, the player wins according to a plurality of different quantity of matches. In one embodiment, if fifteen (15) or more balls have numbers that match the numbers in either fields 18 or 20, an award is provided according to the top or bottom field table 16, including a plurality of different free play awards (e.g., for fifteen (15), sixteen (16), or seventeen (17) matches in one embodiment). All free play awards are winners, and in one embodiment, provide for three (3) extra balls.

It is noted that variations of the awards or other display screen features may be used in some embodiments. In some embodiments, for an additional wager (e.g., if the player gets only fourteen (14) matches in one of the fields 18 or 20), the player may earn a free play. In another embodiment, no matches at all may earn a free play.

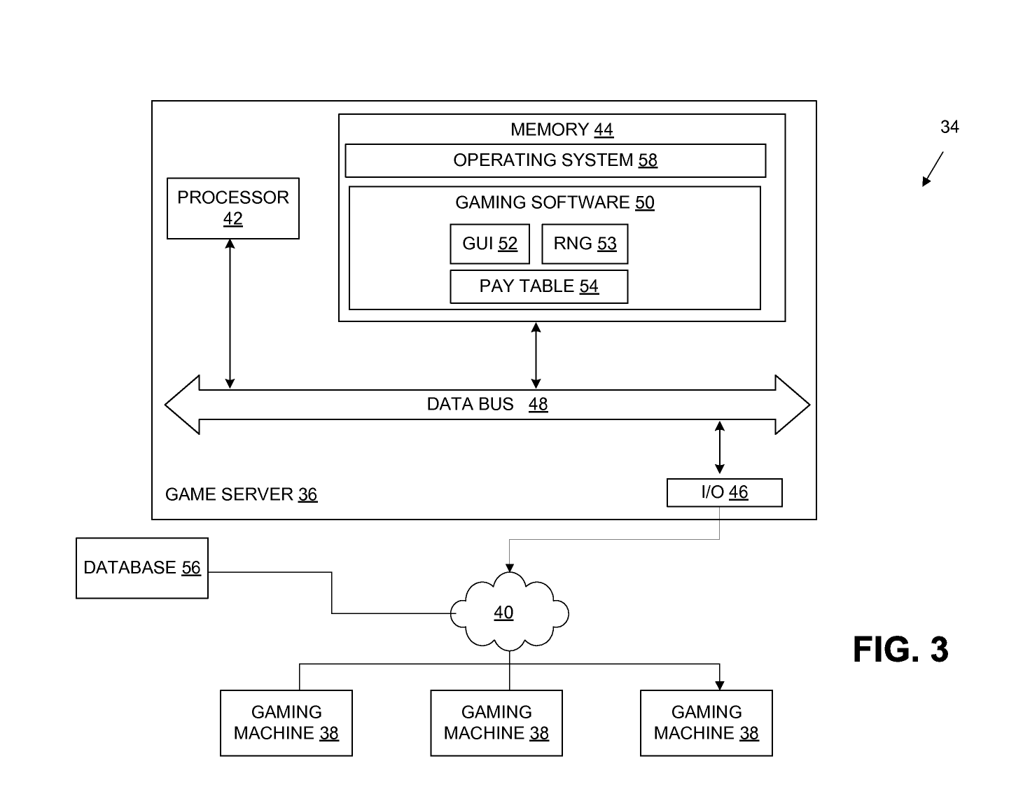

Attention is now directed to FIG. 3, which depicts an embodiment of an example symbol matching game system 34. It should be appreciated within the context of the present disclosure that fewer, additional, or different components may be used in some embodiments, and hence are contemplated to be within the scope of the disclosure. The symbol matching game system 34 comprises one or more game servers 36 (one shown) that is coupled to a plurality of individual gaming machines 38 (e.g., a bank of three (3) gaming machines 38 in this example, though fewer or greater numbers of gaming machines 38 may be used) via a network 40 (e.g., a local area network (LAN) such as an Ethernet connection, a wide area network (WAN), WiFi, etc.). Each gaming machine 38 may be located locally or remotely with respect to one another. The game server 36 includes one or more processors 42, memory 44, and an input/output (I/O) interface 46, coupled together via one or more data busses, such as data bus 48.

In one embodiment, the game server 36 can implement gaming software 50. The gaming software 50 can be implemented in software, as an executable program, and can be executed by a special or general purpose digital computer, such as a personal computer (PC, IBM-compatible, Apple-compatible, or otherwise), workstation, minicomputer, or mainframe computer. The gaming software 50 includes a graphical user-interface (GUI) module 52 that, through execution by the processor 42, provides the display screens described above. Web-page or display screen generation and formatting mechanisms involved in generating the various displays are known in the art and, therefore are not discussed here. The gaming software 50 also includes one or more data structures, such as one or more pay table(s) 54. The gaming software 50 enables, through the use of the GUI 52, the pay table(s) 54, among other data structures, and execution by the processor 42, the provision of top and bottom field outcomes according to one or more additional entries in the pay table 54.

In some embodiments, the gaming software 50 may be located wholly or partially in the gaming machine 38 or may be split between the game server 36 and the gaming machine 38. Often the RNG 53 resides in the game server 36 while the remainder of the gaming software 50 resides in the gaming machine 38.

The pay table 54 includes some conventional features well-known in the art. For instance, the pay table defines all possible outcomes of one play of a game that can result in awarding a prize to a player. Each entry in the pay table may correspond to the amount of money required to be played, the criteria that defines a win (e.g., symbols of symbols), the odds of the win criteria resulting from one play of the game, and the amount of money (e.g., a list of payouts) returned by the gaming machine to the player when the win is registered, in addition to the top and bottom field matching outcomes. The underlying mechanisms for determining how many of the machine generated numbers are to match the numbers in the top and bottom fields 18 and 20 (and how many of the machine generated numbers are to match the player selected picks) may be implemented in different ways depending on the jurisdiction hosting the game. For instance, in one embodiment, a random number generator (RNG) 53 truly picks a defined quantity of balls at random. Random number generation may be achieved through hardware, or a combination of hardware and software. Alternatively, an outcome may be selected from a random process, where the outcome may be that there are fifteen (15) matches in the top or bottom fields 18 or 20, which in turn awards the player three (3) free plays. In this implementation, the machine generated numbers are not randomly selected, but rather, the machine generated numbers are created to provide the outcome the pay table entry designates (e.g., three (3) free plays, six (6) matches on the ten-pick, etc.). In other words, in some jurisdictions, such as tribal markets, there is an underlying bingo game that has a pay table, and one of the outcomes in the pay table is a ten pick that provides for six (6) matches and three (3) free plays. In some implementations, there is no explicit random generation, but rather, a pool of outcomes as stored in a data structure. In one embodiment, the outcomes are randomized, arranged in the data structure, and read sequentially from the data structure. Such an outcome (e.g., analogous to an electronic pulltab or lottery ticket) may be designated as winning six (6) out of ten (10) and the provision of three (3) free plays.

Additional software modules (integrated with the gaming software 50 or separate in some embodiments) are also included in the memory 44. Although shown integral to the gaming software 50, one having ordinary skill in the art should understand in the context of this disclosure that the GUI module 52, the pay table 54, the RNG 53, and/or any other data structures may be separate modules or structures distributed among various components or devices, and that each module may be further configured using a plurality of submodules. In some embodiments, all or a portion of the aforementioned functionality associated with the gaming software 50 may be distributed among a plurality of devices of the symbol matching game system 34, or performed in each device of the system 34. For instance, in some embodiments, the gaming software 50 (and accompanying modules) may be located in each gaming machine 38, in addition to or in lieu of being located in game server(s) 36.

The data bus 48 may be, for example, one or more buses or other wired or wireless connections, and may have additional elements (not shown) to enable communications, such as controllers, buffers (caches), drivers, repeaters, and receivers. Further, the data bus 48 may include address, control, and/or data connections to enable appropriate communications among the aforementioned components. The game server 36 and/or gaming machines 38 may also communicate with a database 56 via the network 40. The database 56 may be external to or integral to game server 36.

The processor 42 is a hardware device capable of executing software, particularly that stored in memory 44. The processor 42 can be any custom made or commercially available processor, a central processing unit (CPU), an auxiliary processor among several processors associated with the game server 36, a semiconductor based microprocessor (in the form of a microchip or chip set), a macroprocessor, or generally any device for executing software instructions.

The memory 44 comprises a non-transitory, computer-readable medium, and may include any one or combination of volatile memory elements (i.e., random access memory) such as DRAM, SRAM or SDRAM and non-volatile memory elements such as ROM, hard drive, tape or CDROM. Moreover, the memory 44 may incorporate electronic, magnetic, optical, and/or other types of storage media. Note that memory 44 can have a distributed architecture where various components are situated remote from one another but can be accessed by the processor 42.

The software in memory 44 may include one or more separate programs, each of which comprises an ordered listing of executable instructions for implementing logical functions. In one embodiment of the game server 36, the software in the memory 44 includes the gaming software 50 and a suitable operating system (O/S) 58. The operating system 58 controls the execution of other computer programs, such as the gaming software 50, and provides scheduling, input-output control, file and data management, memory management, and communication control and related services, as is known.

The gaming software 50 may be a source program, executable program (object code), script, and/or any other entity comprising a set of instructions to be performed. When a source program, the program may be translated via a compiler, assembler, interpreter, or the like, which may or may not be included within memory 44, so as to operate properly in connection with the operating system 58. Furthermore, the gaming software 50 can be written as (a) an object oriented programming language, which has classes of data and methods, or (b) a procedure programming language.

The gaming software 50 may be stored on any non-transitory, computer readable medium for use by or in connection with any computer related system or method. In the context of this document, a computer readable medium is an electronic, magnetic, optical, or other physical device or means that can contain or store a computer program for use by or in connection with a computer related system or method. The gaming software 50 can be embodied in any non-transitory, computer-readable medium for use by or in connection with an instruction execution system, apparatus, or device, such as a computer-based system, processor-containing system, or other system that can fetch the instructions from the instruction execution system, apparatus, or device and execute the instructions.

The I/O interfaces or devices 46 may include input devices such as a keyboard, mouse, scanner, grid from a touch-display screen, electromechanical buttons, microphone, etc., as well as interfaces to various devices (e.g., an interface to one or more gaming machines 38 as shown in FIG. 2). Furthermore, the I/O devices 46 may also include output devices, such as a printer, display, etc. Finally, the I/O devices 46 may further include devices that communicate both inputs and outputs, for instance a modulator/demodulator (modem for accessing another device, system, or network), a radio frequency (RF) or other transceiver, a telephonic interface, a bridge, a router, etc. In one embodiment, a separate progressive display device (e.g., to display progressive bonuses or awards remote from the gaming machines 38) may be connected to the I/O interface 46.

When the game server 36 is in operation, the processor 42 is configured to execute software stored within memory 44, to communicate data to and from memory 44, and to generally control operations of game server 36 pursuant to the software. The gaming software 50 and the operating system 58, in whole or in part, but typically the latter, are read by the processor 42, perhaps buffered within the processor 42, and then executed.

To the extent certain components of the game server 36 are implemented at least in hardware, such functionality may be implemented with any or a combination of the following technologies, which are all well-known in the art: a discrete logic circuit(s) having logic gates for implementing logic functions upon data signals, an application specific integrated circuit (ASIC) having appropriate combinational logic gates, a programmable gate array(s) (PGA), a field programmable gate array (FPGA), etc.

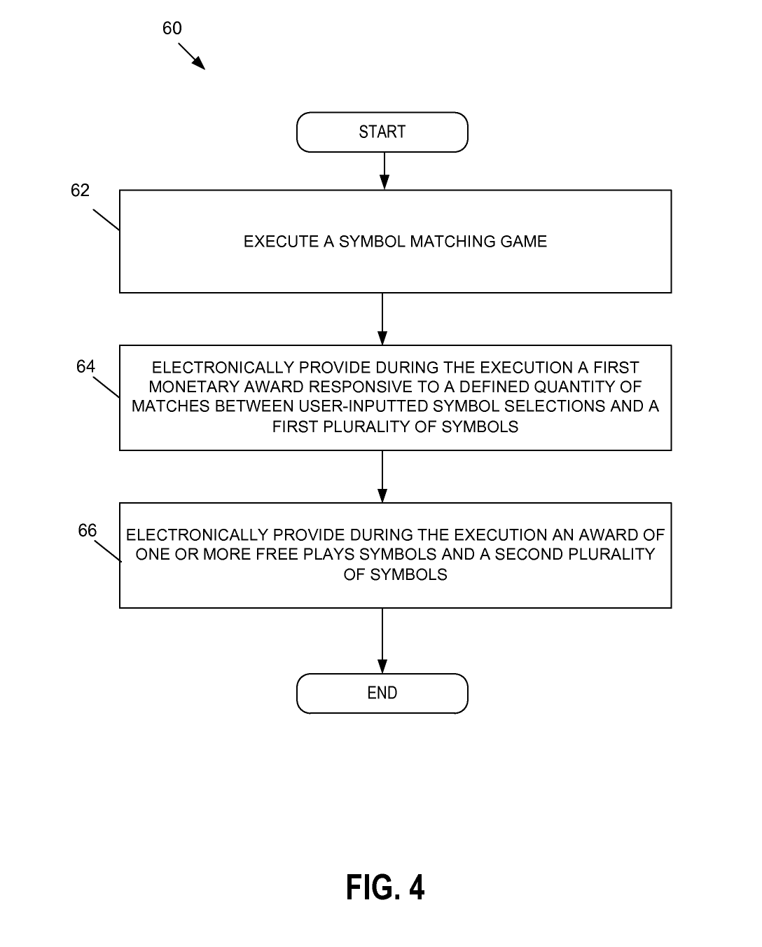

Having described an example embodiment of a symbol matching game system 34, and in view of the above description, it should be appreciated that one embodiment of a symbol matching game method, as depicted in FIG. 4 and denoted as method 60, comprises executing a symbol matching game (62); electronically providing during the execution a first monetary award responsive to a defined quantity of matches between user-inputted symbol selections and a first plurality of symbols (64); and electronically providing during the execution an award of one or more free plays (66).

Any process descriptions or blocks in flow diagrams should be understood as representing modules, segments, or portions of code which include one or more executable instructions for implementing specific logical functions or steps in the process, and alternate implementations are included within the scope of the embodiments in which functions may be executed out of order from that shown or discussed, including substantially concurrently or in reverse order, depending on the functionality involved, as would be understood by those reasonably skilled in the art of the present disclosure.

It should be emphasized that the above-described embodiments of the present disclosure are merely possible examples of implementations, merely set forth for a clear understanding of the principles of the disclosure. Many variations and modifications may be made to the above-described embodiment(s) of the disclosure without departing substantially from the spirit and principles of the disclosure. All such modifications and variations are intended to be included herein within the scope of this disclosure and protected by the following claims.

At least the following is claimed:

1. A system, comprising:
a display device;
a memory configured to store software; and
a processor configured by the software to execute a symbol matching game by:
presenting on the display device a first plurality of symbols evenly distributed among visually-demarcated first and second fields;
receiving a first set of inputs corresponding to symbol selections;
generating a second plurality of symbols responsive to play activation;
presenting the second plurality of symbols proximally to the first plurality of symbols on the display device;
providing a first monetary award responsive to a defined quantity of matches between the symbol selections corresponding to the first set of inputs and the first plurality of symbols; and
providing an award of one or more free plays responsive to a defined quantity of matches between the first plurality of symbols and the generated second plurality of symbols in either the first field or the second field.

2. The system of claim 1, wherein the processor is further configured by the software to execute the symbol matching game by presenting on the display device a table that defines different quantities of free plays based on plural defined quantities of matches between the first plurality of symbols and the generated second plurality of symbols in either the first field or the second field.

3. The system of claim 1, wherein the processor is further configured by the software to execute the symbol matching game by presenting on the display device a table that defines different monetary awards based on symbol selections corresponding to the first set of inputs and the first plurality of symbols.

4. The system of claim 1, wherein the processor is further configured by the software to execute the symbol matching game by presenting on the display device one or more progressive jackpot awards.

5. The system of claim 1, wherein the processor is further configured by the software to execute the symbol matching game by presenting on the display device a first count of the quantity of matches between the first plurality of symbols and the generated second plurality of symbols in the first field and a second count of the quantity of matches between the first plurality of symbols and the generated second plurality of symbols in the second field.

6. The system of claim 1, wherein the symbol matching game comprises Keno.

7. The system of claim 1, wherein the symbol matching game comprises Bingo.

8. The system of claim 1, wherein the symbol matching game comprises Lotto.

9. The system of claim 1, wherein the processor is further configured by the software to execute the symbol matching game by providing the award of the one or more free plays further based on receiving an extra wager.

10. A system comprising:
a plurality of gaming machines;
a game server coupled to the plurality of gaming machines over a network, the game server configured to:
execute a symbol matching game; and
during execution:
present to a player a first monetary award responsive to a defined quantity of matches between user-inputted symbol selections and a first plurality of symbols; and
present to a player an award of one or more free plays.

11. The system of claim 10, wherein during the execution, the game server is further configured to present on a display device the first plurality of symbols distributed among visually-demarcated first and second fields.

12. The system of claim 11, wherein during the execution, the game server is further configured to present on the display device a table that defines different quantities of free plays based on plural defined quantities of matches between the first plurality of symbols and the second plurality of symbols in either the first field or the second field.

13. The system of claim 11, wherein during the execution, the game server is further configured to present on the display device a table that defines different monetary awards based on symbol selections corresponding to the user-inputted symbol selections and the first plurality of symbols.

14. The system of claim 11, wherein during the execution, the game server is further configured to present on the display device one or more progressive jackpot awards.

15. The system of claim 11, wherein during the execution, the game server is further configured to present on the display device a first count of the quantity of matches between the first plurality of symbols and the second plurality of symbols in the first field and a second count of the quantity of matches between the first plurality of symbols and the second plurality of symbols in the second field.

16. The system of claim 10, wherein the free plays are awarded responsive to a defined quantity of matches between the first plurality of symbols and a second plurality of symbols.

17. The system of claim 10, wherein the free plays are awarded responsive to matching predesignated symbols between the first plurality of symbols and a second plurality of symbols or matching random symbols between the first plurality of symbols and the second plurality of symbols.

18. The system of claim 10, wherein the free plays are awarded based on a predetermined probability of based on an external event.

19. A method, comprising:
executing a symbol matching game;
electronically providing during the execution a first monetary award responsive to a defined quantity of matches between user-inputted symbol selections and a first plurality of symbols; and
electronically providing during the execution an award of one or more free plays.

20. The method of claim 19, wherein electronically providing during the execution the award of one or more free plays is responsive to a defined quantity of matches between the first plurality of symbols and a second plurality of symbols.
